(19) United States
(12) Patent Application Publication
(10) Pub. No.: US 2005/0093684 A1
(43) Pub. Date: May 5, 2005

(54) Frame assembly for a license plate

(76) Inventor: Cole J. Cunnien, Canton, MI (US)

Correspondence Address: Mr. Robin W. Asher;Clark Hill, P.L.C., Suite 3500, 500 Woodward Avenue, Detroit, MI, 48226-3435, US

(21) Appl. No.: 10/975,886

(22) Filed: Oct. 28, 2004

Related U.S. Application Data
(60) Provisional application No. 60/515,877, filed on Oct. 30, 2003.

(51) Int. Cl. B60Q 1/00

(52) U.S. Cl. 340/435; 348/148; D12/193; 40/204

(57) ABSTRACT

A frame assembly positions a license plate along a back end of a motor vehicle. The frame assembly includes a base frame adapted to be secured along the back end of the motor vehicle to retain the license plate thereto. A camera is secured to the base frame to produce an image representing an area adjacent to and behind the back end of the motor vehicle. A camera light is fixedly secured to the base frame for illuminating the area adjacent to and behind the back end of the motor vehicle. The camera light assists the camera in producing the image during low lighting conditions.

### FIELD OF THE INVENTION

This invention relates to a frame assembly for a license plate. More particularly, the invention relates to a frame assembly for a license plate that incorporates a camera and a lighting mechanism to assist camera operation in low lighting conditions.

### DESCRIPTION OF RELATED ART

A motor vehicle operator utilizes a rear view mirror to see an area behind the motor vehicle. The rear view mirror does not, however, allow the operator to view a space immediately behind the rear of the motor vehicle. This space is typically referred to as a rear blind spot. The rear blind spot is especially problematic in sport utility vehicles and minivans.

To address this problem, various rear vision systems have been developed that provide the motor vehicle operator with a complete view of the space behind the motor vehicle. Typically, such a rear vision system includes at least one rearwardly facing camera mounted on the motor vehicle. The camera transmits an image to a display device in a passenger compartment enabling the motor vehicle operator to view a real time rearward image. It is, however, difficult to receive a clear signal from the camera in covered areas or at night. Thus, rear vision systems also incorporate a lighting mechanism to illuminate the space behind the motor vehicle. These added systems detract from the aesthetics of the motor vehicle and require additional fasteners to attach to the vehicle.

### SUMMARY OF THE INVENTION

The disadvantages of the prior art may be overcome by providing a license plate holder fitted with a camera and rearward lighting. According to one aspect of the invention, there is provided a license plate holder mountable at the rear of a motor vehicle. The holder has a frame assembly that includes a housing. A camera is mounted within the housing and produces a rearward image. A light is fixedly secured to the housing for rearward illumination. The light assists the camera in producing the rearward image during low lighting conditions.

### BRIEF DESCRIPTION OF THE DRAWINGS

Advantages of the invention will be readily appreciated as the same becomes better understood by reference to the following detailed description when considered in connection with the accompanying drawings wherein:

FIG. 1 is a rear perspective view of a motor vehicle including a license plate retained within a frame assembly according to the invention;

FIG. 2 is a rear, perspective view of the frame assembly;

FIG. 3 is an exploded, rear perspective view of the frame assembly;

FIG. 4 is a cross-sectional view of the frame assembly taken along lines 4-4 in FIG. 2; and

FIG. 5 is a cross-sectional view of the frame assembly taken along lines 5-5 in FIG. 2.

### DETAILED DESCRIPTION OF THE PREFERRED EMBODIMENT

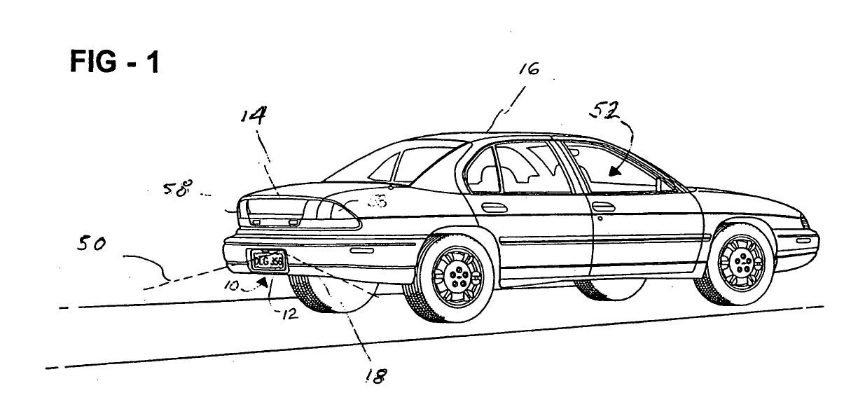

Referring to FIG. 1, a license plate holder, generally shown at 10, for mounting a license plate 12 on the rear end 14 of a motor vehicle 16. More specifically, the license plate holder 10 is disposed preferably on a rear bumper 18 of the motor vehicle 16. It is, however, appreciated that the license plate holder 10 may be mounted at various places along the back end 14 of the motor vehicle 16 including, but not limited to, a rear fascia, a decklid, and a tailgate.

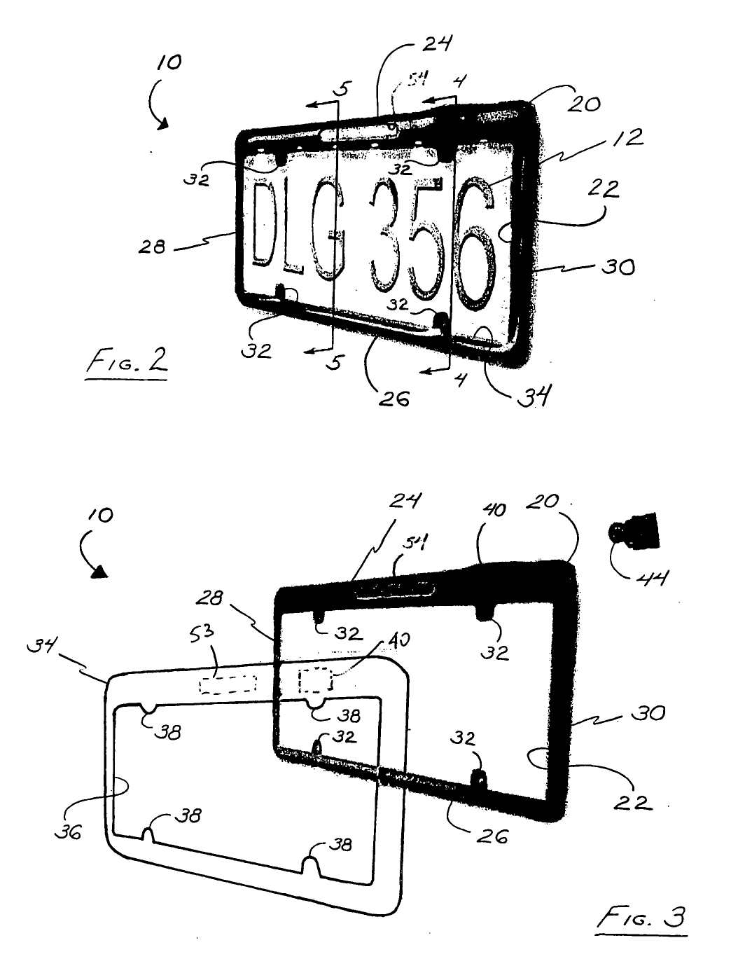

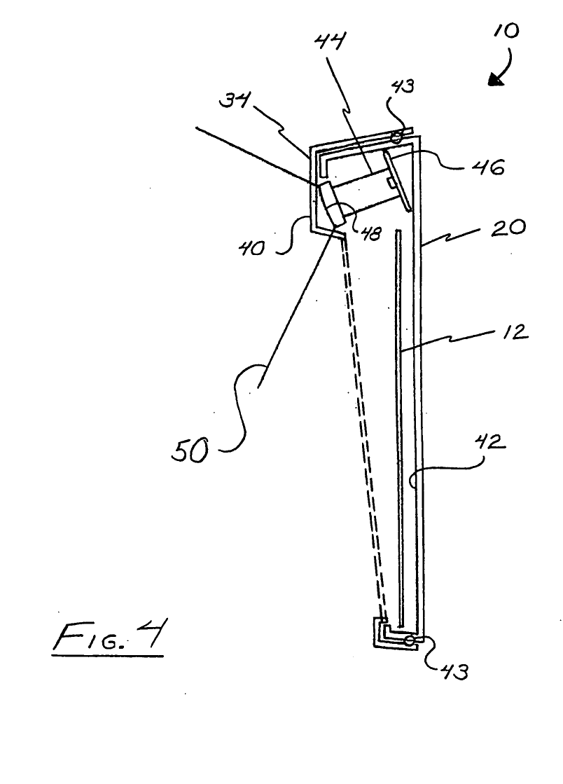

Referring to FIGS. 2 and 3, the license plate holder 10 includes a generally rectangular base frame 20 having an opening or window 22. The license plate 12 is retained within the opening 22 such that license plate numbers and letters are visible from behind the motor vehicle 16, as required by law.

The base frame 20 includes an upper segment 24, a lower segment 26, and sides 28, 30 extending therebetween. The upper 24 and lower 26 segments and the sides 28, 30 define the opening 22. The upper segment 24 has thickness that is greater than the thickness of the lower segment 26. The base frame 20 also includes apertured mounting tabs 32 along the upper 24 and lower 26 segments for receiving a fastener to attach the base frame 20 to the motor vehicle 16. The base frame 20 is preferably molded from an organic plastic material, preferably of an opaque color.

A cover 34 is secured to the base frame 20. The cover 34 includes apertured mounting tabs 38 that align with the mounting tabs 32 of the base frame 20 enabling the license plate holder to be secured the cover 34 and to the vehicle 16 with suitable fasteners. The cover 34 is preferably transparent, and is formed from acrylic, polycarbonate, or a like material.

The shape of the cover 34 complements that of the base frame 20, i.e., the cover 34 is generally rectangular and defines a cover opening or window 36. It is, however, contemplated that the cover 34 may be formed without the cover opening 36 so that the cover 34 extends over the entire license plate 12, as illustrated in broken lines in FIG. 4. The cover 34 has an upper segment 25 that cooperates with upper segment 24 of the base frame 20 to define an interior cavity 42. The interior cavity can extend along the entire width of the license plate holder 10 or merely portions thereof sufficient to house the camera 44 and lights 54, 56. The cover 34 cooperates with the base frame 20 to define a camera window 40, a camera lighting window 53 and a license plate lighting window 57.

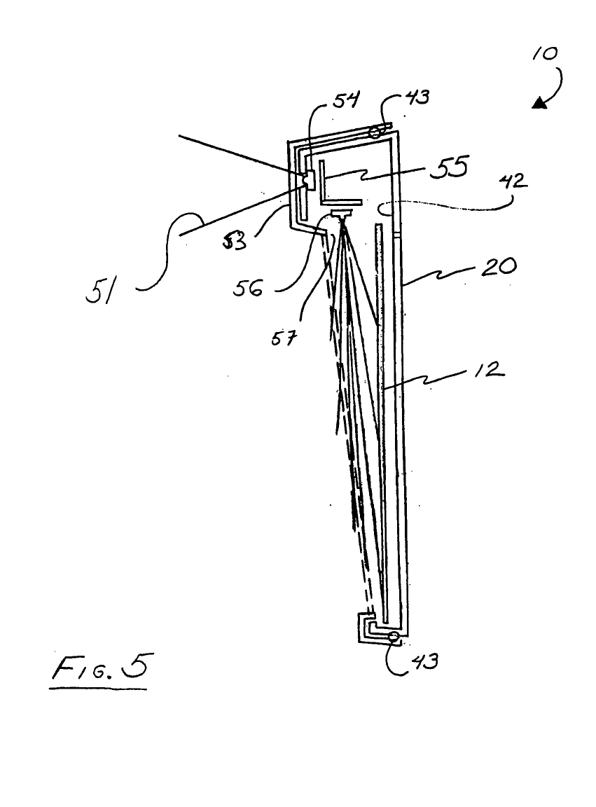

Referring to FIGS. 4 and 5, a seal 43 extends around the periphery of the base frame 20 to seal the base frame 20 with the cover 34.

A camera 44, a camera light 54, and a license plate light 56 are each disposed within the interior 42 to receive or project light through the respective windows 40, 53, 57. The cover 34 protects the camera 44, the camera light 54, and the license plate light 56 from damage that could be caused by tampering and the environment, namely sun, rain, dust, salt, etc.

Referring specifically to FIG. 4, the camera 44 is fixedly secured to the base frame 20 along a circuit board 46. The camera 44 includes a lens 48 that focuses on a space 50, best shown in FIG. 1, rearwardly of the motor vehicle 16. The transparency of the cover 34 allows the lens 48 to receive light enabling the camera 44 to output a rearward image of the vehicle.

The camera 44 may be incorporated as part of a rear vision system, which includes a display screen (not shown) positioned within a passenger compartment 52 of the motor vehicle 16. The camera 44 produces an image that is then transmitted to the display screen to provide the motor vehicle operator with a real-time rearward image. Alternatively, the camera 44 may be connected to a simple notification that may merely alerts the motor vehicle operator that an object is present in the rear blind spot. A notification device may include a light or a noise generator.

The camera 44 is activated when the motor vehicle 16 is shifted into reverse gear to provide the motor vehicle operator with a rearward field of view 51 while backing up the motor vehicle 16. Alternatively, the camera 44 may be activated at all times during motor vehicle operation to assist the motor vehicle operator while driving.

Referring to FIG. 5, the camera light 54 is fixedly secured to the base frame 20 along a circuit board 55. The camera light 54 is rearwardly and downwardly projected to illuminate the space 50 to assist the camera 44 in producing low light images. The cover 34 allows light emitted from the camera light 54 to pass through window 40 and illuminate the field of view 50.

Generally, activation of the camera light 54 will coincide with that of the camera 44, that is, the camera light 54 will be activated when the motor vehicle 16 is shifted into reverse gear. In a preferred embodiment, the camera light 54 is a light emitting diode (LED) or an array of LED's disposed along the upper segment 24 of the base frame 20.

The license plate light 56 is also fixedly secured to the base frame 20 along circuit board 55 thereof. The license plate light 56 illuminates the license plate 12, and is activated with running lights 58 of the motor vehicle 16. In the preferred embodiment, the license plate light 56 is an LED or array of LED's.

The invention has been described in an illustrative manner. It is to be understood that the terminology, which has been used, is intended to be in the nature of words of description rather than of limitation. Many modifications and variations of the invention are possible in light of the above teachings and thus the invention may be practiced other than as specifically described.

1. A license plate holder for mounting on a motor vehicle, said license plate holder comprising:
a base frame;
a cover cooperating with said base frame to define an interior cavity, said cover having at least one window enabling a license plate to be visible therethrough;
a camera mounted within said cavity, said camera for producing an image from beyond said cover;
a camera light fixedly secured to said base frame for illuminating an area focused upon by said camera enabling said camera in producing the image during low lighting conditions; and
a license plate light mounted within said cavity and directed to illuminate the license plate.

2. A frame assembly as set forth in claim 1, wherein said cover is transparent.

3. A frame assembly as set forth in claim 2, wherein said license plate light is disposed within said interior and directed to illuminate an area behind said window.

4. A frame assembly as set forth in claim 2, wherein said assembly further comprises a seal extending between said cover plate and said base frame.

5. A frame assembly as set forth in claim 2, wherein at least one of said camera light and said license plate light is an LED.

6. A frame assembly as set forth in claim 2, wherein said camera light and said license plate light are LED's.

7. A frame assembly as set forth in claim 1, wherein said cover plate and said base frame cooperate to define a camera window, a camera light window and a license plate light window and said camera is mounted behind said camera window, said camera light is mounted behind said camera light window and said license plate light is mounted behind said license plate light window.

8. A frame assembly as set forth in claim 7, wherein said cover is transparent.

9. A frame assembly as set forth in claim 8, wherein said assembly further comprises a seal extending between said cover plate and said base frame.

10. A frame assembly as set forth in claim 9, wherein at least one of said camera light and said license plate light is an LED.

11. A frame assembly as set forth in claim 9, wherein said camera light and said license plate light are LED's.

12. A frame assembly as set forth in claim 8, wherein said at least one window is open.

13. A frame assembly as set forth in claim 8, wherein said cover plate and said base plate cooperate to enable a license plate to be mounted therebetween and to a vehicle.

14. A frame assembly as set forth in claim 13, wherein said cover plate and said base plate have cooperating apertured tabs for receiving fasteners.
